(19) United States
(12) Patent Application Publication
(10) Pub. No.: US 2007/0041662 A1
(43) Pub. Date: Feb. 22, 2007

(54) Efficient scaling of image data

(76) Inventor: Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/209,017

(22) Filed: Aug. 22, 2005

(51) Int. Cl. G06K 9/32

(52) U.S. Cl. 382/298

(57) ABSTRACT

One preferred embodiment is directed to a scaling unit for scaling an image. The scaling unit comprises a fetching unit, a vertical scaler, and a horizontal scaler. The fetching unit is for receiving a first group of pixels. The group includes at least one first pixel of a first line and at least one first pixel of a second line. The first pixel of the first line and the first pixel of the second line are vertically adjacent. The vertical scaler is for creating at least one vertically scaled pixel from the first group. The horizontal scaler is for creating at least one horizontally scaled pixel from at least two vertically scaled pixels. Preferred embodiments eliminate the need for a line buffer for temporarily storing horizontally scaled lines, and the processing overhead associated with its use.

### FIELD OF THE INVENTION

The present invention relates generally to image data processing, and particularly to methods and apparatus for efficient scaling of image data.

### BACKGROUND

A mobile device may be, for example, a mobile telephone, personal digital assistant, digital camera, or digital music player. Mobile devices typically rely primarily on a battery for power. To maximize battery life in these devices, it is important to minimize power consumption.

Mobile devices commonly have graphics display systems that includes a host, a camera, a display device, and a graphics controller. The graphics controller drives the display device, and interfaces the host and the camera with one another and with the display device. The graphics controller commonly includes an embedded memory for storing image data. In graphics controllers, it is important to minimize the size of the memory, which reduces cost and also reduces power requirements. In addition, the graphics controller commonly includes logic for performing various image processing operations. One operation that graphics controllers are often called on to perform is image scaling.

Digital images are two dimensional arrays of pixels (a “frame”). The pixels in a display device are generally updated or “refreshed” in a raster scan pattern, that is, from side to side in lines from top to bottom. In addition, frames of pixels are commonly stored in memory, fetched from memory, and written to the display device in raster order.

When an image is scaled horizontally, it is typically scaled a line at a time in raster order. If the image is also to be scaled vertically, several of the scaled lines may be temporarily stored in a memory. Two of the horizontally scaled lines are subsequently used to create one or more new lines for vertically scaling the image. The memory in which the horizontally scaled lines are stored is referred to as a “line buffer.”

The line buffer requires an amount of memory which is not insignificant in a graphics controller used in a mobile device. Typically, at least two horizontally scaled lines of the image need to be stored in the line buffer. For example, for if the image is a 640×480 pixel array, the line buffer must be able to store two lines or 1280 pixels. At 24 bpp, this means that 3.75 kB of memory is needed.

It would be desirable to reduce or eliminate the memory required for the line buffer, especially in battery-powered mobile devices. In addition, power and processing time are required to use the line buffer, and it would be desirable to reduce or eliminate the processing overhead associated with the line buffer. Accordingly, a method and apparatus for efficient scaling of image data in graphics display systems would be desirable.

### SUMMARY

The invention is directed to methods and apparatus for efficient scaling of image data in graphics display systems.

In a preferred embodiment, a method for scaling an image, includes receiving a first and second groups of pixels. The first group includes at least one first pixel of a first line and at least one first pixel of a second line. The first pixel of the first line and the first pixel of the second line are vertically adjacent. The second group includes at least one second pixel of the first line and at least one second pixel of the second line. The second pixel of the first line and the second pixel of the second line are again vertically adjacent. The method includes a step of creating at least one first vertically scaled pixel from the first group, and at least one second vertically scaled pixel from the second group. At least one horizontally scaled pixel is created from the first and second vertically scaled pixels.

An alternative preferred embodiment is directed to a scaling unit for scaling an image. The scaling unit comprises a fetching unit, a vertical scaler, and a horizontal scaler. The fetching unit is for receiving a first group of pixels. The group includes at least one first pixel of a first line and at least one first pixel of a second line. The first pixel of the first line and the first pixel of the second line are vertically adjacent. The vertical scaler is for creating at least one vertically scaled pixel from the first group. The horizontal scaler is for creating at least one horizontally scaled pixel from at least two vertically scaled pixels.

In another preferred embodiment, a graphics display system includes a memory for storing an image, a graphics controller, and a bus coupling the memory and the graphics controller. The graphics controller includes a fetching unit, a vertical scaler, and a horizontal scaler. The fetching unit is for fetching a first group of pixels from the memory. The group includes at least one first pixel of a first line and at least one first pixel of a second line. The first pixel of the first line and the first pixel of the second line are vertically adjacent. The vertical scaler is for creating at least one vertically scaled pixel from the first group. The horizontal scaler for creating at least one horizontally scaled pixel from at least two vertically scaled pixels; and

Yet another is directed to a machine readable medium embodying a program of instructions executable by a machine. The program of instructions when executed by the machine preferably performs a method for scaling an image, includes receiving a first and second groups of pixels. The first group includes at least one first pixel of a first line and at least one first pixel of a second line. The first pixel of the first line and the first pixel of the second line are vertically adjacent. The second group includes at least one second pixel of the first line and at least one second pixel of the second line. The second pixel of the first line and the second pixel of the second line are again vertically adjacent. The method includes a step of creating at least one first vertically scaled pixel from the first group, and at least one second vertically scaled pixel from the second group. At least one horizontally scaled pixel is created from the first and second vertically scaled pixels.

The objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a conceptual diagram illustrating 4-point horizontal interpolation of an image.

FIG. 2 illustrates horizontally expanded lines resulting from 4-point horizontal interpolation.

FIG. 3 is a conceptual diagram illustrating 2-point vertical interpolation of an image.

FIG. 4 is a block diagram of an exemplary scaling unit for scaling an image.

FIG. 5 is a block diagram of a scaling unit for scaling an image according to a preferred embodiment of the invention.

FIG. 6 is a block diagram of a graphics display system that includes a graphics controller having the scaling unit of FIG. 5, illustrating a preferred context for the invention.

### DETAILED DESCRIPTION OF PREFERRED EMBODIMENTS

Preferred embodiments of the invention are directed to methods and apparatus for efficient scaling of image data in graphics display systems. Reference will now be made in detail to the present preferred embodiments of the invention, examples of which are illustrated in the accompanying drawings. Wherever possible, the same reference numbers are used in the drawings and the description to refer to the same or like parts.

The image on a display screen is formed from an array of small discrete elements (“pixels.”) The attributes of each pixel, such as its brightness and color, are represented by a numeric value, which is typically represented in binary form. Thus, an image can also be considered as an array of binary elements of data. For convenience of explanation and in accordance with the use of the term in the art, the term pixel is used herein to refer at times to the display elements of a display device, at times to the binary elements of data that are stored and manipulated within a graphics display system and which define the attributes of such display elements, and at times to both, the appropriate sense of the term being clear from the context.

When an image is enlarged in two dimensions, pixels may be received from an image data source, such as a camera. Typically, the first line received is horizontally scaled, and temporarily stored in a line buffer until another line can be scaled. After the first line is scaled, the next lower line of the image is horizontally scaled. Horizontal scaling enlarges the image horizontally.

As pixels of the second line are scaled, two steps typically occur in parallel. The second line is stored in the line buffer for use in subsequent scaling operations, and the pixels of the second scaled line are combined with pixels from the first scaled line in an interpolation process that creates a new line of pixels. The new line is inserted between the first and second scaled lines thereby vertically enlarging the image.

An image may be vertically enlarged by inserting exactly one line between each line of the original image. In addition, an image may be enlarged in different degrees by inserting more that one new line between the first and second scaled lines. When the image is to be enlarged in greater degrees, the pixels of the first and second scaled lines are repeatedly fetched from the line buffer and combined to produce as many new lines as desired. Where one new line is produced, the first and second scaled lines are generally given equal weight in the interpolation process. Where more than one new line is produced, the first and second scaled lines are generally given different weights in each of the interpolation processes.

Generally, the above-described process for scaling an image streamed from a camera is also used when the image is stored in a memory.

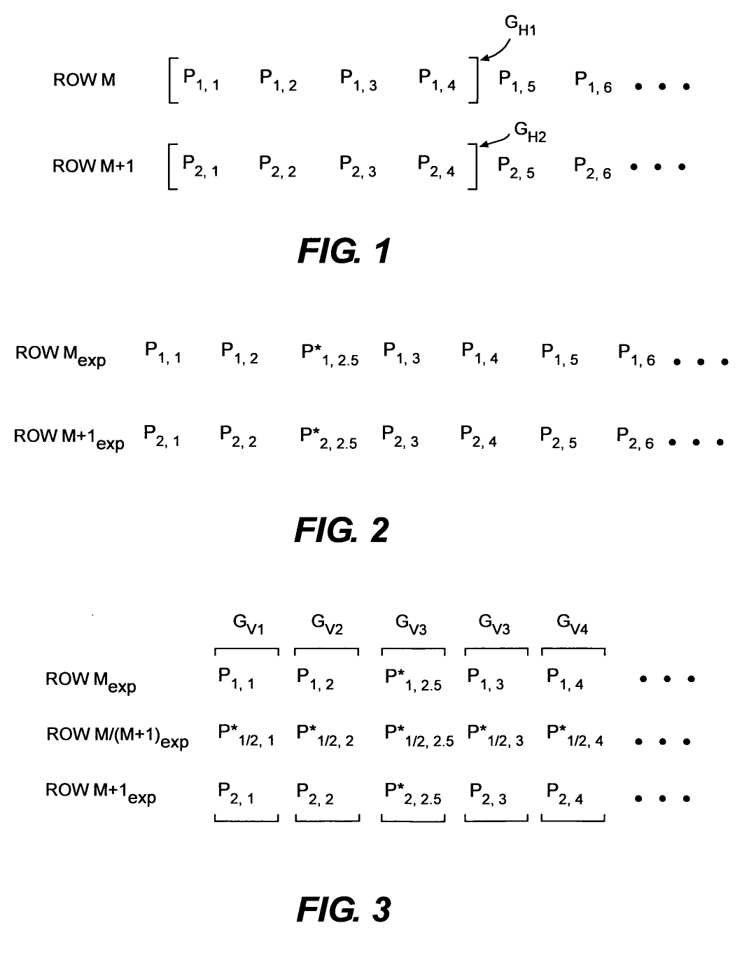

FIGS. 1, 2, and 3 illustrate exemplary interpolation methods for creating new pixels by combining image data corresponding to existing pixels.

FIG. 1 illustrates an exemplary 4-point horizontal interpolation method. FIG. 1 shows portions two rows, M and M+1, of an original image. The pixels are numbered P_{m,n}, where m is a row index and n is a column index (the first 6 pixels in rows 1 and 2 are shown). Neighboring pixels in a row are grouped together in horizontal 4-pixel groups “G_{H}” (indicated in brackets).

As shown in FIG. 2, the pixels in the groups are combined to produce one new pixel P* that is inserted centrally into the group. For example, pixels P_{1,1}, P,_{1,2}, P_{1,3}, and P_{1,4} in the group G_{H1} may be averaged to produce a new pixel P*_{1,2,5}, which is shown inserted centrally in the group G_{H1}. The new pixel expands the image horizontally by increasing the length of the row M. The horizontal interpolation method produces expanded rows Rmₑₓₚ and Rm+1ₑₓₚ.

In other horizontal interpolation methods, a number of pixels other than one may be created from a group of 4 pixels, e.g., 2 pixels may be created. Further, a pixel may be created from a group having a size other than 4 pixels, e.g., groups having 3 pixels or 5 pixels.

FIG. 3 illustrates an exemplary 2-point vertical interpolation method. FIG. 3 shows portions of the horizontally expanded rows M and M+1 of FIG. 2, and a new row M/(M+1)ₑₓₚ that results from vertical scaling. The expanded rows Mₑₓₚ and M+1ₑₓₚ are created by horizontally expanding adjacent or consecutive rows M and M+1 of the original image. The pixels of the rows Mₑₓₚ and M+1ₑₓₚ are paired into vertical groups “G_{V}” (indicated in brackets) of two pixels. For example, the pixels P_{1,1} and P_{2,1} are paired in the group G_{V1}. The two pixels in each group G_{V} are combined to produce a new pixel P*. For example, the pixels P_{1,1} and P_{2,1} in the group G_{V1} may be combined by averaging to produce a corresponding new pixel P*_{1/2,1}.

The 2-point vertical interpolation method may be used to produce one or more new rows M/( M+1)ₑₓₚ for insertion between the rows Mₑₓₚ and M+1ₑₓₚ. If only one row is inserted, the pixels of each row are typically given equal weight in the interpolation. However, if two or more rows are inserted, the pixels of each row are typically given different weights in successive iterations of the interpolation.

While FIGS. 1 and 2 illustrate horizontal expansion, interpolation may also be employed to down-scale an image horizontally. For example, the four pixels in the groups “G_{H}” may be combined to produce fewer than four new pixels, e.g., three pixels, that replace the group. Replacing groups of four pixels with three pixels would shrink the image horizontally. Similarly, while FIG. 3 illustrates vertical expansion, interpolation may also be employed to down-scale an image vertically. For example, the two pixels in each group may be combined to produce a new pixel that would replace the pixels in the group G_{H}. Thus, the two rows Mₑₓₚ and M+1ₑₓₚ would be replaced by a single row M/(M+1)ₑₓₚ, shrinking the image vertically. Depending on the degree of scaling, the new row may replace more than two rows.

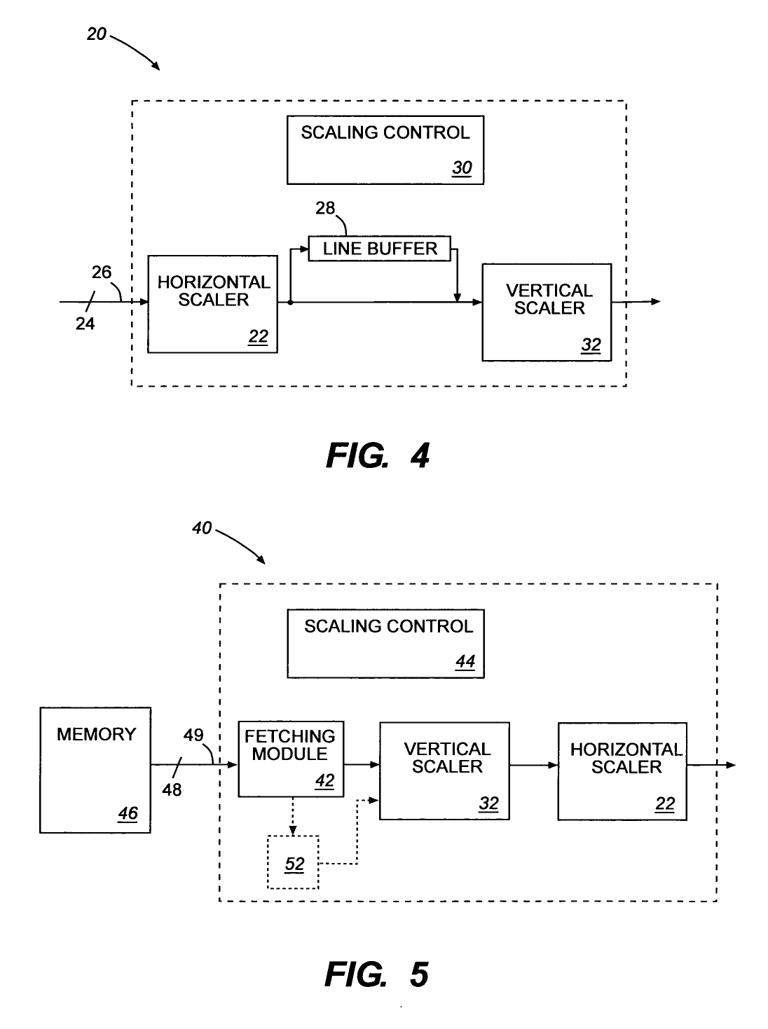

When the method shown in FIGS. 1, 2, and 3 is employed, a line buffer is required for temporarily storing the expanded rows Mₑₓₚ and M+1ₑₓₚ. FIG. 4 shows an exemplary scaling unit 20 that includes such a line buffer 28. The image to be scaled may be provided by an image data source, such as a camera, or fetched from a memory. Whatever the source, pixels are provided in raster order to a horizontal scaler 22 over a bus 26. The bus 26 is preferably a 24-bit parallel bus. The exemplary horizontal scaler 22 expands a line horizontally by performing the 4-point horizontal interpolation described above. A scaling control module 30, among other functions, directs the output of the horizontal scaler 22. The scaling unit 20 includes a vertical scaler 32 for expanding an image vertically by performing the 2-point vertical interpolation described above.

In operation, a first step comprises receiving a line M, either from a camera or a memory, and feeding the fetched line through the horizontal scaler 22. A horizontally expanded line Mₑₓₚ is output from the horizontal scaler 22 and stored in the line buffer 28. A line M+1 is then received and fed through the horizontal scaler 22. As the horizontally expanded line M+1ₑₓₚ is output from the horizontal scaler, it is sent to the vertical scaler 32 along with the horizontally expanded line Mₑₓₚ, which is read out from the line buffer 28. The vertical scaler 32 thus receives groups of pixels G_{V} which it combines to create new pixels. Once a scaled line, e.g., M/(M+1)ₑₓₚ has been output, the vertical scaler 32 will have output one line of vertically scaled data, which is some interpolated version of scaled lines Mₑₓₚ and M+1ₑₓₚ. Many different interpolated versions are possible, depending on the weightings given to the pixels in the groups G_{H} by the horizontal scaler 22, and the weightings given to the pixels the groups of pixels G_{V} by the vertical scaler 32.

At the same time that the horizontally scaled line M+1ₑₓₚ is output from horizontal scaler 22 and fed to the vertical scaler 32, the scaled line M+1ₑₓₚ is also written to the line buffer 28. The line buffer 28 is large enough for storing two horizontally expanded lines so this does not disturb the line previously stored line. Accordingly, once the horizontally expanded line M+1ₑₓₚ has been completely output from the horizontal scaler 22, two horizontally expanded lines, Mₑₓₚ and M+1ₑₓₚ, will be stored in the line buffer 28.

If a frame is being vertically up-scaled, the scaling controller 30 may determine that additional lines are required to be interpolated between scaled lines Mₑₓₚ and M+1ₑₓₚ. If so, the scaled lines Mₑₓₚ and M+1ₑₓₚ are read out of the line buffer 28 (as many times as is necessary) and sent to the vertical scaler 32. The multiplier coefficients used for interpolating the scaled lines Mₑₓₚ and M+1ₑₓₚ will be different for each additional new line, so each new lines will be different from the others. Additional new lines, each with different multiplier coefficients, may be produced from the horizontally scaled lines stored in the buffer 28 until the scaling controller 30 determines that a sufficient number of lines have been created.

When the scaling controller 30 determines that a sufficient number of lines have been interpolated, the above described steps are repeated with a new line of the original image. The above described sequence of steps are repeated until the entire image has been processed. Each time the sequence is repeated, the first step comprises receiving a new line the memory. When this first step is performed, a decision must be as to which new line of the original image to use. If the frame is being vertically up-scaled, the new line will be line M+2. However, if the frame is being vertically down-scaled, this new line may be a line Y, where Y≧M+2. In this case, a line received from the camera may be discarded, or if the image is being fetched from memory, one or more lines may be skipped.

Preferred embodiments of the present invention eliminate the need for the line buffer 28, and eliminate the processing overhead associated with the line buffer. In addition, preferred embodiments are directed to enlarging an image stored in a memory. While the exemplary method scaling method and apparatus described with reference to FIGS. 1, 2, 3, and 4 is for enlarging an image, the principles of the invention are not limited to enlarging an image. Further, while the example of FIGS. 1, 2, 3, and 4 scales an image in two dimensions using 4-point and 2-point interpolation, the principles of the invention are not limited to a particular scaling method. It is believed that the principles of the invention may be employed with any up-scaling or down-scaling method known in the art.

FIG. 5 shows a scaling unit 40 for scaling an image both horizontally and vertically according to a preferred embodiment of the present invention. The scaling unit 40 eliminates the line buffer 28 and the processing overhead associated with its use. The scaling unit 40 provides the advantages of maximizing battery life in mobile devices by minimizing power consumption. The power needed to write and fetch pixels from the line buffer 28 in the unit 20 is not needed with unit 40. Another advantage is that the size of the memory used in a graphics controller that includes a scaling circuit is reduced when the scaling unit 40 is employed instead of the scaling unit 20. Reducing memory size reduces cost and also reduces power requirements. A further advantage is that processing time is improved by eliminating the time required for a first row of data to propagate through the line buffer.

Referring to FIG. 5, the scaling unit 40 preferably includes a vertical scaler 32 and a horizontal scaler 22. In addition, the scaling unit 40 preferably includes a fetching module 42 and a control module 44. The scaling units 20 and 40 preferably employ the same vertical scaler 32 and the horizontal scaler 22.

In a preferred embodiment, the image or frame to be scaled is stored in a memory 46. Pixels are fetched from the memory 46 by the fetching module 26 over a bus 49, and presented to the vertical scaler 32. A scaling control module 44 directs the fetching module 26 to fetch particular lines from the memory 46. The fetching module 26 fetches groups of pixels G_{V}. The bus 49 is preferably a 48-bit parallel bus, which is wide enough for two 22-bit pixels.

In a preferred embodiment, the vertical scaler 32 employs 2-point interpolation and therefore must be fed two lines at once. The image stored in the memory is logically divided into two fields. A first field includes all of the even numbered lines and a second field includes all of the odd numbered lines. For example, if the image is 8 lines, the first field is lines 2, 4, 6, and 8, and the second field is lines 1, 3, 5, and 7. Preferably, the fields are fetched and presented to the vertical scaler 32 in parallel. For instance, lines 1 and 2 are fetched in parallel. In addition, pixels from the same column the image are preferably fetched at the same time, or at substantially the same time, e.g., P_{1,1}, and P_{2,1} of the group G_{V1} are fetched simultaneously.

While pixels in like columns of the first and second fields are preferably placed on the bus 49 in the same memory cycle, in an alternative embodiment, the two pixels in the group G_{V} may be fetched sequentially in two memory cycles using a narrower bus, e.g., the bus 26, provided that the two pixels are presented to the vertical scaler 32 at the substantially the same time. For example, in an alternative embodiment, a register 46 may be provided for temporarily storing a first pixel while the other pixel in the group G_{V} is fetched. An embodiment employing the 24-bit bus 26 would require different timing requirements from embodiments employing the 48-bit bus 49. Other embodiments may employ busses of any width, provided that two pixels of a group G_{V} are presented in substantially simultaneously to the vertical scaler 32.

The scaling control module 44 directs the fetching module 26 to fetch pixels from the rows M and M+1. The fetched rows are fed to the vertical scaler 32 which produces a new interpolated row M/(M+1). This row M/(M+1) is fed to the horizontal scaler 22. The horizontal scaler 22 produces a horizontally expanded row M/(M+1)ₑₓₚ. While the horizontal scaler 22 preferably employs 4-point interpolation, this is not essential.

In operation, assuming the image is to be up-scaled, two lines are fetched in parallel from the memory 46 by the fetching unit 42 and fed to the vertical scaler 32. Preferably, the fetched lines are preferably from different fields and are adjacent to one another in the image. Two vertically adjacent pixels, e.g., a group G_{V}, are fed to the vertical scaler 32, which outputs a new line. This new line is fed to the horizontal scaler 22 a pixel at a time. When the horizontal scaler 22 receives enough pixels to perform a horizontal interpolation, e.g., a group G_{H}, it outputs a new pixel.

When up-scaling an image vertically, it may be desired to interpolate a pair of lines more than once in order to produce more than one new line for insertion between the two original lines. If the scaling control module 44 determines that an additional lines are required, it directs the fetching module 42 to fetch from the memory 46 the two original lines previously fetched. The two original lines are presented to the vertical scaler 32 and the vertical scaler creates new pixels from groups G_{V}. When additional lines are produced in this manner, the vertical scaler 32 preferably gives the pixels in each of the groups G_{V} a different weight for each successive line. Further, when additional lines are produced, the vertical scaler 32 feeds each new line to the horizontal scaler 22. For each new line fed to the horizontal scaler 22, it produces a new horizontally scaled line for insertion between the two original lines.

When down-scaling an image vertically, each original line of the image may be fetched for creating a new line which may be used to replace the two original lines. When an image is scaled by different degrees, it may not be necessary to fetch all of the original line of the image in order to create the new lines which make up the down-scaled image.

Herein, the phrase “vertically adjacent” is used to refer to pixels from the same group G_{V}. When up-scaling an image vertically, the pair of lines from the original image are typically successive lines of the image, e.g. line M, and line M+1. When down-scaling an image vertically, the pair of lines from the original image may not be successive lines of the image. For example, the line M, and the line M+2 may be vertical interpolated. Accordingly, the phrase “vertically adjacent” is not limited to pixels in the same column in successive lines of the image, but includes pixels any lines which are not directly adjacent vertically. In addition, while the pixels in a group G_{V} are preferably from the same column of the array, this is not essential.

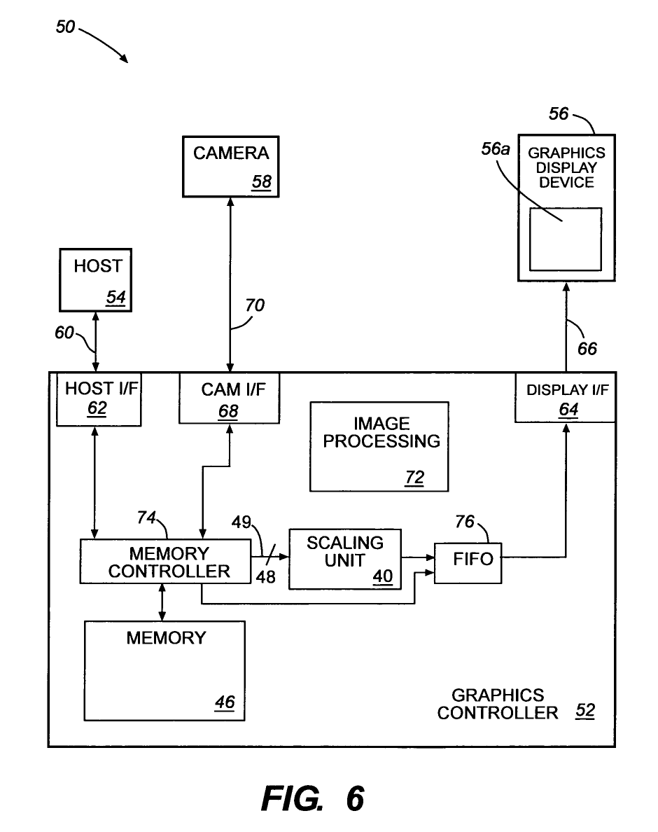

Preferred embodiments are directed to a graphics controller employing the scaling module 40. Turning now to FIG. 6, a graphics display system 50 is shown, which illustrates one preferred context for the invention. The graphics display system 50 includes a graphics controller 52 according to one preferred embodiment of the present invention. The system 50 may be any digital system or appliance. Where the system 50 is a portable digital appliance, it is typically powered by a battery (not shown). The system 50 typically includes a host 54, a graphics display device 56, and a camera module 58. The graphics controller 52 drives the display device and interfaces the host and the camera module with the display device. Preferably, the graphics controller 52 is a separate IC from the remaining elements of the system, that is, the graphics controller is “remote” from the host, camera, and display device.

The host 54 is typically a microprocessor, but may be a digital signal processor, a computer, or any other type of controlling device adapted for controlling digital circuits. The host 54 communicates with the graphics controller 52 over a bus 60 via a host interface 62 in the graphics controller.

The graphics controller 52 includes a display device interface 64 for interfacing between the graphics controller and the display device 56 over display device bus 66. LCDs are typically used as display devices in portable digital appliance, such as mobile telephones, but any device(s) capable of rendering pixel data in visually perceivable form may be employed. The display device 56 has a display area 56a. In an alternative embodiment, the display device 56 is a printer. The graphics controller 52 also includes a camera interface 68 (“CAM I/F”) for receiving pixel data output on data lines of a bus 70 from the camera 58.

In addition to the scaling operations performed by the scaling unit 40, a number of other image processing operations may be performed on data provided by an image data source, such as the host or the camera. Such image processing operations may be performed by units included in an image processing block indicated generally as 72. The image processing block 72 may include, for example, a CODEC for compressing and decompressing image data, and a color converter for converting the color format of the data. Image processing operations, such as cropping, compression encoding, and color converting, may be performed as the data are received, “on the fly,” or they may be performed on data that have been stored in a memory.

In a preferred embodiment, the graphics controller 52 includes a memory 46 for storing image data. Access to the memory is controlled by a memory controller 74. In other embodiments, however, the memory 46 may be remote from the graphics controller. The memory 46 is preferably an SRAM, however, any type of memory may be employed.

Image data stored in the memory 46 may fetched and transmitted through a display pipe 76, which is preferably a FIFO buffer. The output of the display pipe is transmitted through the display device interface 64 to the display device 56. If it is desired to enlarge the image stored in the memory 46, the image data may be fed to the scaling unit 40 for scaling. The scaled output may then be provided to the display pipe for subsequent display or to another module for further processing or other disposition. In one alternative embodiment, for example, the scaled output of the scaling unit 40 is stored in a nonvolatile memory, such as a flash memory card.

While the image data to be scaled by the scaling unit 40 is preferably stored in a memory, such as the memory 46, this is not essential to all embodiments of the invention. For example, if a pair of lines of an original image need to be vertically interpolated only once in order to produce a single new line for insertion between the two original lines, it is not necessary to have the image stored in memory. As another example, if the image source (other than a memory) has the ability to repeatedly feed the same line to the scaling unit 40, it is not necessary to have the image stored in a memory.

An example illustrates operation of the system 50. An image is presented to the graphics controller 52 by the camera source. Alternatively, the image may be presented by the host or another image data source. The image is stored in the memory 46. The image may be down-scaled before being stored, but this is optional. The image is subsequently fetched from the memory 46 and enlarged vertically and horizontally by the scaling unit 40 as previously described. The up-scaled image is fed to the display pipe 76 for presentation to the display device 56.

In addition, invention is directed to a machine readable medium, such as magnetic or optical disks, hard disk drives, memory chips of any type, and other similar memory devices. Preferably, the medium embodies a program of instructions that may be executed by a machine, such as a computer system. The program of instructions may be software, firmware, hardware code, or other similar program. The program of instructions, when executed by the machine, performs a method of: (a) receiving two pixels of a group G_{V}, (b) creating a new pixel from the group of pixels G_{V} for vertical insertion into the image. After a sufficient number of new vertical pixels are created, e.g., a four pixels forming a group of G_{H}, (c) another new pixel for horizontal insertion into the group G_{H} is created.

The terms and expressions that have been employed in the foregoing specification are used as terms of description and not of limitation, and are not intended to exclude equivalents of the features shown and described or portions of them. The scope of the invention is defined and limited only by the claims that follow.

I claim:

1. A method for scaling an image, comprising:
receiving a first group of pixels including at least one first pixel of a first line and at least one first pixel of a second line, the first pixel of the first line and the first pixel of the second line being vertically adjacent;
receiving a second group of pixels including at least one second pixel of the first line and at least one second pixel of the second line, the second pixel of the first line and the second pixel of the second line being vertically adjacent;
creating at least one first vertically scaled pixel from the first group, and at least one second vertically scaled pixel from the second group; and
creating at least one horizontally scaled pixel from the at least one first and second vertically scaled pixels.

2. The method of claim 1, wherein the pixels included in the first group are received at substantially the same time.

3. The method of claim 2, wherein the pixels included in the first group are fetched from a memory in the same memory cycle.

4. The method of claim 1, wherein the first group of pixels includes one first pixel of a first line and one first pixel of a second line, and the first vertically scaled pixel is created using 2-point interpolation.

5. The method of claim 4, wherein the horizontally scaled pixel is created from the first and second vertically scaled pixels, and from a third and fourth vertically scaled pixels using 4-point interpolation.

6. An scaling unit for scaling an image, comprising:
fetching unit for receiving a first group of pixels, the group including at least one first pixel of a first line and at least one first pixel of a second line, the first pixel of the first line and the first pixel of the second line being vertically adjacent;
a vertical scaler for creating at least one vertically scaled pixel from the first group; and
a horizontal scaler for creating at least one horizontally scaled pixel from at least two vertically scaled pixels.

7. The scaling unit of claim 6, further comprising a memory for storing the image, wherein the fetching unit is adapted for fetching first group of pixels from the memory.

8. The scaling unit of claim 7, wherein the fetching unit fetches the pixels included in the first group in parallel from the memory.

9. The scaling unit of claim 7, wherein the fetching unit fetches the pixels included in the first group in two memory cycles and is adapted to present said pixels to the vertical scaler at substantially the same time.

10. The scaling unit of claim 7, wherein the vertical scaler is adapted to create the at least one vertically scaled pixel using 2-point interpolation.

11. The scaling unit of claim 10, wherein the horizontal scaler is adapted for creating the at least one horizontally scaled pixel using 4-point interpolation.

12. A graphics display system, comprising:
a memory for storing an image;
a graphics controller that includes:
a fetching unit for fetching a first group of pixels from the memory, the group including at least one first pixel of a first line and at least one first pixel of a second line, the first pixel of the first line and the first pixel of the second line being vertically adjacent;
a vertical scaler for creating at least one vertically scaled pixel from the first group; and
a horizontal scaler for creating at least one horizontally scaled pixel from at least two vertically scaled pixels; and
a bus coupling the memory and the graphics controller.

13. The graphics display system of claim 12, wherein the width of the bus is sufficient for simultaneously fetching two pixels from the memory.

14. The graphics display system of claim 12, wherein the width of the bus is sufficient for simultaneously fetching one pixel from the memory, further comprising a register for storing one pixel of the first line while one pixel of a second line is fetched from the memory.

15. The graphics display system of claim 12, wherein the vertical scaler is adapted to create the at least one vertically scaled pixel using 2-point interpolation.

16. The graphics display system of claim 15, wherein the horizontal scaler is adapted for creating the at least one horizontally scaled pixel using 4-point interpolation.

17. The graphics display system of claim 12, wherein the graphics controller and the memory are remote from one another.

18. The graphics display system of claim 12, further comprising a display device for receiving scaled images, wherein the graphics controller is remote from the display device.

19. The graphics display system of claim 12, further comprising a camera for transmitting images to the graphics controller, wherein the graphics controller is remote from the camera.

20. The graphics display system of claim 12, further comprising a host for controlling the graphics display system, wherein the graphics controller is remote from the host.
